(19) United States
(12) Patent Application Publication
(10) Pub. No.: US 2023/0061763 A1
(43) Pub. Date: Mar. 2, 2023

(54) INSPECTION CHIP AND LIQUID INTRODUCTION METHOD

(71) Applicants: SEKISUI CHEMICAL CO., LTD., Osaka (JP); SEKISUI MEDICAL CO., LTD., Tokyo (JP)

(72) Inventors: Takuya KINOSHITA, Osaka (JP); Takamasa KOUNO, Osaka (JP); Katsura UCHIDA, Tokyo (JP); Sou YAMAGUCHI, Tokyo (JP); Masato NISHIKAWA, Osaka (JP)

(21) Appl. No.: 17/800,344

(22) PCT Filed: Jun. 18, 2021
(86) PCT No.: PCT/JP2021/023204

§ 371 Date: Aug. 17, 2022

(30) Foreign Application Priority Data
Jun. 22, 2020 (JP) 2020-107246

(51) Int. Cl. B01L 3/00

(52) U.S. Cl. CPC B01L 3/5023; B01L 2200/0689; B01L 2300/047; B01L 2400/0683; B01L 2200/16; B01L 2300/069

(57) ABSTRACT

An inspection chip includes: a body part including a microchannel; and a liquid introduction part introducing liquid into the microchannel. The liquid introduction part includes: a liquid reception part; and a lid part capable of sealing the liquid reception part. The liquid reception part includes: a liquid storage part having an opening part in an upper part thereof; and a connection part connected to the microchannel from a bottom part of the liquid storage part. The lid part includes a protrusion part that protrudes so as to be housed in the liquid storage part.

### TECHNICAL FIELD

The present invention relates to an inspection chip and a liquid introduction method using the inspection chip.

### BACKGROUND ART

Recently, various tests such as a blood test and a genetic test as well as biochemical analysis have been performed using an inspection chip having microchannels to control supply and/or reactions of various kinds of specimens and samples. Especially in the fields such as the medical field and the biochemical field, there is a demand for downsizing and simplifying analytical equipment. Also, high-speed analysis and analyzing a trace specimen are required.

In the conventional inspection chip, sampling equipment such as a micropipette or a syringe is generally used at the time of introduction of liquid such as a specimen into a microchannel. That is, dedicated sampling equipment is needed, which also requires complicated operations.

Patent Document 1 discloses, as one example, a microchip having a configuration in which a sample liquid introduction port communicated with a starting terminal of a liquid passageway is formed on the same plane as a gas supply port communicated with an ending terminal of a gas passageway, and a seal material is disposed to surround the sample liquid introduction port and the gas supply port. Thus, a vial can be directly connected to the sample liquid introduction port.

### PRIOR ART DOCUMENT

### Patent Document

[Patent Document 1] JP 5754190

### SUMMARY OF THE INVENTION

### Problem to be Solved by the Invention

However, in the conventional inspection chip, a liquid feeding method using compressed air is adopted as a method for feeding the introduction liquid. Although there also is a passive feeding method using capillary action as the liquid feeding method, these methods take time to send the liquid. Furthermore, when the compressed air is used, it is also necessary to provide a dedicated compressed air generator.

The present invention was made in consideration of the above circumstances, an object of which is to provide an inspection chip and a liquid introduction method in which liquid such as a specimen is simply and rapidly introduced into a microchannel without any dedicated compressed air generator to introduce the liquid.

### Means for Solving the Problem

In order to achieve the above object, an inspection chip of the present invention includes: a body part including a microchannel; and a liquid introduction part introducing liquid into the microchannel. The liquid introduction part includes: a liquid reception part into which the liquid is injected; and a lid part capable of sealing the liquid reception part. The liquid reception part includes: a liquid storage part having an opening part in an upper part thereof; and a connection part connecting the liquid storage part and the microchannel. The lid part includes a protrusion part that protrudes so as to be fitted in the opening part and housed in the liquid storage part when the liquid reception part is sealed, and furthermore the protrusion part hermetically enters the liquid storage part. The lid part is attached to the liquid reception part, and then the liquid in the liquid storage part is pushed out into the microchannel through the connection part.

With the specific configuration as described above, it is possible to easily seal the liquid reception part by attaching the lid part of the inspection chip to the liquid reception part. At this time, gas encapsulated in the liquid storage part is pushed out by the protrusion part, which pushes the liquid in the liquid storage part to the microchannel. Thus, it is possible to easily introduce the liquid into the microchannel.

Also in the inspection chip having the above configuration, it is preferable that the liquid storage part has an inclined bottom part, and that the connection part connects the lowermost part of the bottom part and the microchannel.

Also in the inspection chip having the above configuration, it is preferable that the protrusion part has a shape such that at least a part of the protrusion part comes into contact with an inner surface of the liquid storage part when the liquid reception part is sealed.

Also in the inspection chip having the above configuration, the lid part may include: the protrusion part; and a base part holding the protrusion part. The protrusion part may be movable with respect to the base part.

Also in the inspection chip having the above configuration, the protrusion part may be formed as a separate body from the base part, and may be detachable from the base part. In this case, it is preferable that the protrusion part includes a locking part capable of being engaged with the base part.

Also in the inspection chip having the above configuration, the protrusion part may include a pressing part that is a recess toward the liquid storage part.

Also in the inspection chip having the above configuration, the base part may include a positioning part that protrudes so as to be fitted in the opening part and housed in the liquid storage part.

Also in the inspection chip having the above configuration, it is preferable that the protrusion part hermetically slides into the liquid storage part when the liquid reception part is sealed.

Also in the inspection chip having the above configuration, the protrusion part may include a sealing protrusion part that protrudes outward from an outer surface of the protrusion part so as to be appressed to an inner surface of the liquid storage part.

Also in the inspection chip having the above configuration, it is preferable that the protrusion part is elastically deformable.

Also in the inspection chip having the above configuration, it is preferable that, in the liquid introduction part, the liquid storage part is provided on the body part so as to protrude from the body part. In this case, an outer surface of the liquid storage part may be provided with a part to be locked with which the lid part is engaged, and the lid part may be provided with a locking part that is engaged with the part to be locked.

Also in the inspection chip having the above configuration, the liquid storage part and the lid part may respectively have thread structures to be threadably engaged with each other, and an external thread formed on either one of the liquid storage part and the lid part may be threadably engaged with an internal thread formed on the other one of the liquid storage part and the lid part.

A liquid introduction method using the inspection chip having the above configuration is also within the technical range of the present invention. That is, in the liquid introduction method using an inspection chip including a liquid introduction part connected to a microchannel, the liquid introduction part includes: a liquid reception part into which liquid is injected; and a lid part capable of sealing the liquid reception part. The lid part has a protrusion part protrudingly provided. The liquid introduction method includes the steps of injecting the liquid into the liquid reception part so that the liquid is stored; and attaching the lid part to the liquid reception part. In the attaching step, the lid part seals the liquid reception part, then, as the protrusion part enters the liquid reception part, gas in the liquid reception part pushes out the liquid into the microchannel, and thus the liquid is introduced into the microchannel.

Also in the liquid introduction method having the above configuration, the protrusion part may be movable with respect to a base part of the lid part, and the protrusion part may enter the liquid reception part by being pressed.

In the above-described configuration, it is possible to easily introduce the liquid in the liquid storage part into the microchannel by a simple operation of sealing the liquid reception part of the inspection chip using the lid part.

### Effects of the Invention

With the present invention, the inspection chip can be provided, which has a simple configuration capable of rapidly introducing and sending liquid.

### BRIEF DESCRIPTION OF THE DRAWINGS

FIG. 1 is a perspective view schematically illustrating an inspection chip according to Embodiment 1 of the present invention.

FIG. 2 is a cross-sectional view schematically illustrating a liquid introduction part of the inspection chip.

FIGS. 3(a) and 3(b) are diagrams for explaining a liquid introduction method using the inspection chip.

FIG. 4 is a cross-sectional view schematically illustrating the liquid introduction part of the inspection chip according to Embodiment 2 of the present invention.

FIG. 5 is a cross-sectional view schematically illustrating another example of the liquid introduction part of the inspection chip.

FIGS. 6(a) and 6(b) are cross-sectional views schematically illustrating the liquid introduction part of the inspection chip according to Embodiment 3 of the present invention.

FIGS. 7(a) and 7(b) are cross-sectional views schematically illustrating the liquid introduction part of the inspection chip according to Embodiment 4 of the present invention.

FIGS. 8(a) and 8(b) are cross-sectional views schematically illustrating the liquid introduction part of the inspection chip according to Embodiment 5 of the present invention.

FIG. 9 is a cross-sectional view schematically illustrating the liquid introduction part of the inspection chip according to Embodiment 6 of the present invention.

FIG. 10 is a cross-sectional view illustrating a state in which a protrusion part provided on a lid part of the liquid introduction part is fitted in a liquid storage part.

FIG. 11 is a cross-sectional view illustrating a state in which the protrusion part is further fitted in the liquid storage part subsequent to the state in FIG. 10.

FIG. 12 is a cross-sectional view schematically illustrating another example of the liquid introduction part of the inspection chip according to Embodiment 6.

FIG. 13 is a cross-sectional view illustrating a state in which the protrusion part provided on the lid part of the liquid introduction part is fitted in the liquid storage part.

### MODE FOR CARRYING OUT THE INVENTION

An inspection chip 1 and a liquid introduction method using the inspection chip 1 according to Embodiments of the present invention will be described with reference to the drawings.

### Embodiment 1

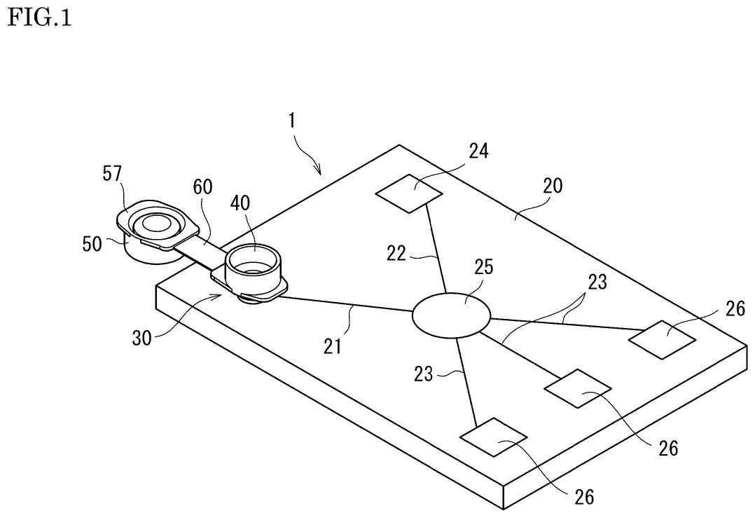

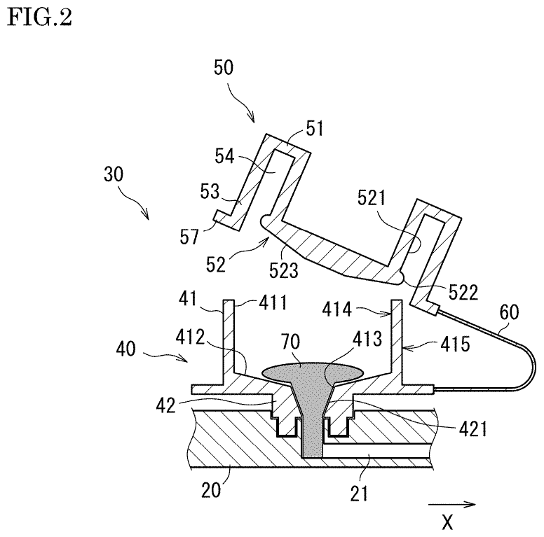

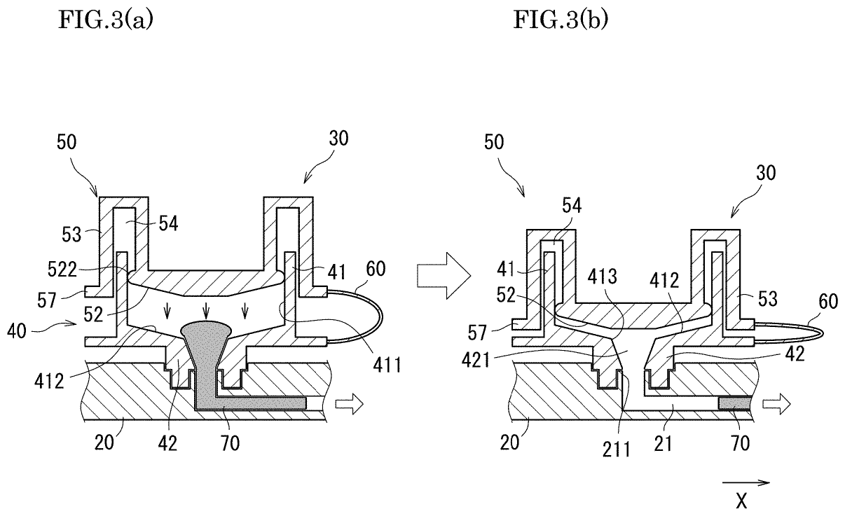

FIG. 1 is a perspective view schematically illustrating the inspection chip 1 according to Embodiment 1. FIG. 2 is a cross-sectional view schematically illustrating a liquid introduction part 30 of the inspection chip 1. FIGS. 3(a) and 3(b) are diagrams for explaining the liquid introduction method using the inspection chip 1.

—Inspection Chip—

As shown in FIG. 1, the inspection chip 1 includes: a body part 20 having a general shape of a rectangular plate; and the liquid introduction part to introduce liquid into a microchannel 21 of the body part 20. As shown in FIGS. 1 and 2, hereinafter a configuration is exemplarily described, in which the liquid introduction part 30 is provided on an upper surface of the body part 20 of the inspection chip 1. Also, the orientation, the vertical direction and the like of the inspection chip 1 are described according to the state shown in FIG. 1. However, it is only for the sake of understandability, and thus does not limit the direction and the like of the inspection chip 1 of the present invention when it is used.

The body part 20 of the inspection chip 1 includes a plurality of microchannels 21, 22 and 23. Among these microchannels, the microchannel 21 is connected to the liquid introduction part 30. In the configuration exemplarily shown, a downstream end of the microchannel 21 and a downstream end of the microchannel 22 are both connected to a reaction part 25 and joined so as to branch into a plurality of microchannels 23. To each downstream end of the microchannels 23, an analysis part 26 is connected.

A gas generation part 24 is provided upstream of the microchannel 22. The gas generation part 24 generates gas by external force such as light or heat. The gas generation part 24 includes, for example, a light gas generating tape that generates gas at a predetermined timing so as to supply the generated gas to the microchannel 22. Thus, trace reagent can be controlled to be supplied, and accordingly, no complicated liquid feeding mechanism is required.

As the liquid injected into the liquid introduction part 30, micro droplets having a volume of, for example, 1 to 500 μl are used. The liquid injected into the liquid introduction part 30 is, for example, a specimen collected from a test subject. When the liquid is a specimen collected from the test subject, an operator is required to store the specimen in the inspection chip 1 every time the test is conducted. In this case also, the specimen can be simply and rapidly introduced into the inspection chip 1 so as to be supplied, not depending on proficiency of the operator.

The microchannels 21, 22 and 23 are channels into which the liquid as described above is fed. Thus, from the viewpoint of reduction in the channel resistance, the respective microchannels 21, 22 and 23 preferably have a cross-sectional size (i.e. width and height, or inner diameter) of the cross-section orthogonally intersecting with the liquid feeding direction X in the range of 0.01 to 10 mm. The channels may have any cross-sectional shape such as a rectangle shape or a circle shape. In FIG. 1, the microchannels 21, 22 and 23 are schematically illustrated each as a straight line, however, the channels may have any shapes.

The liquid introduction part 30 includes a liquid reception part 40 into which the liquid is injected and a lid part 50 capable of sealing the liquid reception part 40. It is preferable that the liquid reception part 40 and the lid part 50 are connected to each other by a belt-shaped joining part 60.

As shown in FIG. 2, the liquid reception part 40 includes, in an integral manner: a liquid storage part 41 having an opened upper part and a bottom part; and a connection part 42 that connects the liquid storage part 41 and the microchannel 21. In FIG. 2, the cross-section is shown in the state in which the lid part 50 is lifted upward from the liquid reception part 40 fixed to the body part 20. The liquid storage part 41 has an opening part 411 in the upper part, and an inclined bottom part 412. The bottom part 412 of the liquid storage part 41 has a tapered shape with a slope descending toward the substantial center part thereof. A connection opening 413 (see FIG. 3(b)) is opened in the lowermost part of the bottom part 412.

The liquid storage part 41 has, for example, a cylindrical shaped inner surface 414, and the bottom part 412 preferably has a funnel shape. An outer surface 415 of the liquid storage part 41 has also a cylindrical shape. The bottom part 412 of the liquid storage part 41 has an inverted cone shape.

The connection part 42 is connected to the connection opening 413 in the lowermost part of the bottom part 412 so as to connect the liquid storage part 41 and the microchannel 21. The connection part 42 is provided so as to protrude downward from the liquid storage part 41. The connection part 42 has a connection channel 421 communicating with the connection opening 413. The connection part 42 is fitted in and fixed to the upper surface of the body part 20. Thus, the connection channel 421 is connected to the upstream end of the microchannel 21 of the body part 20.

The shape of the liquid storage part 41 is not limited to the above-described shape, provided that the liquid storage part 41 has a configuration in which the bottom part 412 is provided with the connection opening 413 that is connected to the connection part 42. For example, the bottom part 412 of the liquid storage part 41 is not particularly required to have an inverted cone shape to the extent that it has a slope. The liquid storage part 41 may have a square-tube shaped inner surface 414 and the bottom part 412 may have an inverted pyramid shape. Also, the connection opening 413 is not particularly required to be provided in the substantial center part of the bottom part 412. The connection opening 413 may be eccentrically provided with respect to the center part of the bottom part 412 to the extent that it is provided in the lowermost part.

The microchannel 21 has a liquid inlet 211 that is opened to the outside of the system on an upstream side of the body part 20 (see FIG. 3(b)). The microchannel 21 extends in the thickness direction (vertical direction) of the body part 20, and is bent to be extended in the liquid feeding direction X that orthogonally intersecting with the thickness direction. On the downstream side of the microchannel 21, the reaction part 25 is provided, which holds, for example, the reagent.

The lid part 50 of the liquid introduction part 30 includes, in an integral manner: a base part 51; a protrusion part 52 that protrudes from one surface of the base part 51; and an outer peripheral wall part 53 that is provided outside the protrusion part 52. The base part 51 has a flat plate shape. The protrusion part 52 and the outer peripheral wall part 53 are provided so as to protrude in the same direction from the base part 51.

The protrusion part 52 has an outer surface smaller than an inner surface of the liquid storage part 41, and protrudes so as to be fitted in the liquid storage part 41 from the opening part 411 and thus is housed in the liquid storage part 41. In this case, an outer surface 521 of the protrusion part 52 is formed to have a cylindrical shape whose outer diameter is, for example, smaller than the inner diameter of the cylindrical shaped liquid storage part 41.

Also, the protrusion part 52 has a sealing protrusion part 522 that protrudes outward from the outer surface 521. The sealing protrusion part 522 is continuously formed on a protruding end part of the protrusion part 52 in the circumferential direction of the outer surface 521, and has an annular shape or a flange shape. The sealing protrusion part 522 is elastic, and is formed to have an outer diameter equal to or larger than the inner diameter of the liquid storage part 41. In this way, when the protrusion part 52 is housed in the liquid storage part 41, the sealing protrusion part 522 of the protrusion part 52 is appressed to the inner surface 414 of the liquid storage part 41.

The protruding end part of the protrusion part 52 faces the bottom part 412 of the liquid storage part 41 when it is housed in the liquid storage part 41. The protrusion part 52 has a tapered part 523 that swells gradually from the protruding end part toward the substantial center part thereof so as to correspond to the bottom part 412 having a tapered shape with a slope descending toward the substantial center part thereof.

Also the protrusion part 52 has a size that does not come into contact with the bottom part 412 of the liquid storage part 41 when the protrusion part 52 is housed in the liquid storage part 41, while at least the sealing protrusion part 522 is appressed to the inner surface 414 of the liquid storage part 41. Thus, when the lid part 50 is attached to the liquid reception part 40 and the protrusion part 52 is housed in the liquid storage part 41, an airtight space is formed between the protrusion part 52 and the bottom part 412. Since the tapered part 523 is provided, the airtight space can be smaller, which contributes to easiness of fitting the protrusion part 52 in the liquid storage part 41.

Note that it does not matter whether the protrusion part 52 comes into contact with the bottom part 412 of the liquid storage part 41 or not when the protrusion part 52 is completely housed in the liquid storage part 41.

The outer peripheral wall part 53 of the lid part 50 is formed to have a cylindrical shape surrounding outside the protrusion part 52 at a predetermined interval from the outer surface 521 of the protrusion part 52. Outside the protrusion part 52, a recess part 54 having a cylindrical shape is formed, which is surrounded by the outer surface 521 of the protrusion part 52, the base part 51 and the outer peripheral wall part 53. The outer peripheral wall part 53 has a protruding length substantially the same as the height of the outer surface 415 of the liquid storage part 41.

Also, the lid part 50 has a knob part 57 extending outward, which is provided on the outer surface of the outer peripheral wall part 53. In the configuration exemplarily shown, the knob part 57 protrudes from the part in the vicinity of the end of the outer peripheral wall part 53, which is opposite to the base part 51. At the time of attaching the lid part 50 to the liquid reception part 40, an operator pinches the knob part 57 and covers the opening part 411 with the lid part 50 easily by bending and deforming the joining part 60.

It is preferable that the liquid reception part 40 and the lid part 50 are each integrally made of a thermoplastic material such as: polypropylene (PP) resin; polyethylene (PE) resin; polystyrene (PS) resin; acrylonitrile butadiene styrene (ABS) resin; polymethyl methacrylate (PMMA) resin; polyvinyl alcohol (PVA) resin; polyvinylidene chloride (PVDC) resin; polyethylene terephthalate (PET) resin; polyamide (PA) resin; polyacetal (POM) resin; polycarbonate (PC) resin; polyvinylidene fluoride (PVDF) resin; polytetrafluoroethylene (PTFE) resin; cycloolefin polymer (COP) resin; or cycloolefin copolymer (COC) resin. More preferably, PP or PE is used as the resin material in the above materials.

The liquid reception part 40 and the lid part 50 may be made of the same resin material or respectively made of different resin materials. It is preferable that at least one of the liquid reception part 40 and the lid part 50 is made of PP or PE.

With the above-described configuration, in the liquid introduction part of the inspection chip 1, the liquid storage part 41 is provided so as to protrude from the body part 20. As shown in FIG. 1, the lid part 50 coupled to the liquid reception part 40 is provided outside of the body part 20. The liquid introduction part 30 may be disposed at any position with respect to the body part 20 of the inspection chip 1, which is not limited to the configuration exemplarily shown. Also, the general shape of the inspection chip 1 is not limited to the rectangular plate exemplarily shown. It may have any shape such as a disc shape or a fan shape.

—Liquid Introduction Method Using Inspection Chip—

In the inspection chip 1 as shown in FIG. 2, the liquid introduction part is provided with the liquid reception part 40, the top part of which is opened. The inspection chip 1 is adopted to detect biological information on virus and the like by introducing liquid (extraction liquid) 70 including a specimen collected, for example, from the nostril or the like of a human body. In this case, firstly, the liquid 70 is injected into the liquid reception part 40 of the liquid introduction part 30. The injected liquid 70 is stored in the bottom part 412 of the liquid storage part 41 and the connection channel 421.

Secondly, the lid part 50 is attached to the liquid reception part 40 (attaching step). In the attaching step as shown in FIG. 3(a), in the process where the liquid reception part 40 is covered with the lid part 50, the protrusion part 52 provided in the lid part 50 enters the liquid storage part 41. The sealing protrusion part 522 of the protrusion part 52 of the lid part 50 hermetically slides on the inner surface 414 of the liquid storage part 41. Thus, the protrusion part 52 is fitted in the liquid storage part 41.

In association with the sealing of the liquid reception part 40 by the lid part 50, gas that exists in the liquid storage part 41 is encapsulated and pushed by the protrusion part 52 so as to flow downward. The gas pushed by the protrusion part 52 further pushes out the liquid 70 in the liquid storage part 41 toward the microchannel 21 through the connection channel 421 of the connection part 42.

By pressing the lid part 50 such that the protrusion part 52 is further fitted in the liquid storage part 41, the liquid 70 is introduced into the microchannel 21 as shown in FIG. 3(b). When the liquid reception part is sealed by the lid part 50, supply of the liquid is started. The liquid 70 introduced into the microchannel 21 is fed from the microchannel 21 to the microchannel 23 on the downstream side via the reaction part 25.

Here, the capacity of the liquid storage part 41 is a maximum amount of liquid 70 capable of being fed. Therefore, it is possible to adjust the feeding amount of liquid depending on the capacity of the liquid storage part 41 provided in the inspection chip 1.

Also, when lid part 50 is attached to the liquid reception part 40 so as to seal the liquid reception part 40, the protrusion part 52 pushes out the liquid 70 via the gas encapsulated in the liquid storage part 41. Thus, the liquid 70 can be introduced into the microchannel 21 without contacting with the protrusion part 52. When the lid part 50 is pressed so that the knob part 57 comes into contact with the liquid reception part 40, the protrusion part 52 is housed in the liquid storage part 41 and the outer peripheral wall part 53 covers the outer surface 415 of the liquid storage part 41. Since the sealing protrusion part 522 of the protrusion part 52 is appressed to the inner surface 414 of the liquid storage part 41, the lid part 50 is hardly detached once the sealing is completed. Thus, the sealed state is stably maintained.

As described above, with the inspection chip 1 according to this Embodiment, it is possible to easily seal the liquid reception part 40 storing the liquid 70 by attaching the lid part 50 to the liquid reception part 40 at the time of introducing the liquid 70 into the inspection chip 1. Also, when the liquid reception part 40 is sealed, the gas encapsulated in the liquid storage part 41 is pushed out by the protrusion part 52 of the lid part 50, which pushes the liquid 70 in the liquid storage part 41 to the microchannel 21. Thus, it is possible to easily introduce the liquid 70.

In this way, it is possible to rapidly feed the liquid 70 to the microchannels 21, 22 and 23, which improves rapidity of analysis of the liquid 70. Furthermore, when introducing the liquid 70, it is sufficient to perform an operation to seal the liquid reception part 40 into which the liquid 70 is injected by the lid part 50, which does not require any dedicated compressed air generator to feed the liquid 70. Thus, it is possible to form the inspection chip 1 with a simple configuration, which contributes reduction of production costs while reducing the size.

### Embodiment 2

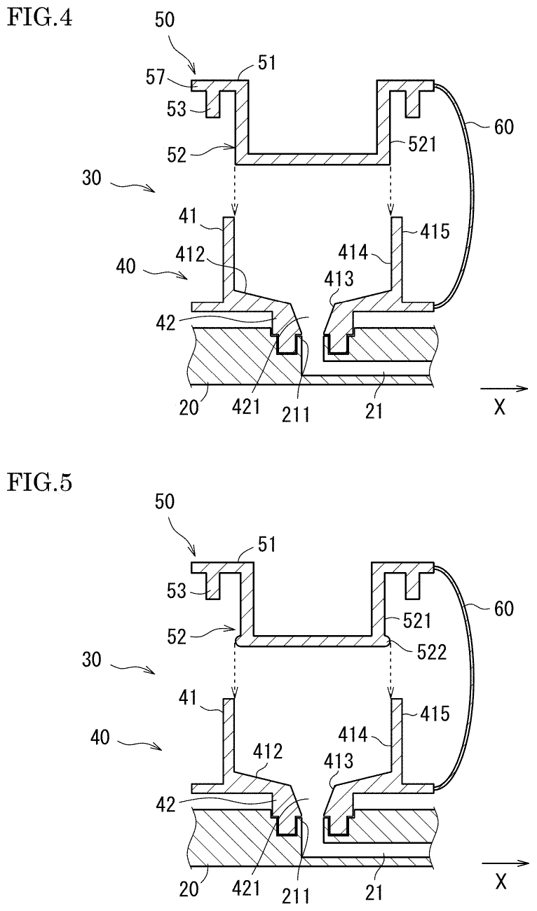

FIGS. 4 and 5 are cross-sectional views schematically illustrating the liquid introduction part 30 of the inspection chip 1 according to Embodiment 2. In Embodiments 2 to 5 described below, the basic configuration of the inspection chip 1 is the same as that shown in Embodiment 1, and respective structures of the liquid introduction part are characteristic. Therefore, the characteristic structures of the liquid introduction part 30 are described in detail, and the other components are indicated by the same reference numerals as Embodiment 1 so as to omit the description thereof.

In Embodiment 1 described above, the inspection chip 1 has a configuration in which the protrusion part 52 of the lid part 50 is provided with the sealing protrusion part 522. However, the configuration of the inspection chip 1 is not limited thereto. It is sufficient for the protrusion part 52 to have a configuration in which at least a part thereof comes into contact with the inner surface of the liquid storage part 41 when the liquid reception part 40 is sealed. Also, the protrusion part 52 is not particularly required to have the above-described configuration to the extent that the protrusion part 52 can hermetically slide into the liquid storage part 41 when the liquid reception part 40 is sealed.

For example, in the inspection chip 1 shown in FIG. 4, the protrusion part 52 of the lid part 50 is not provided with the sealing protrusion part 522 (see FIG. 2). The outer surface 521 of the protrusion part 52 is formed to have a straight cylindrical shape so as to be fitted in the liquid storage part 41. In this case, the outer surface 521 of the protrusion part 52 is pressed so as to slide on the inner surface 414 of the liquid storage part 41, which pushes out the gas in the liquid storage part 41. By the pushed gas, the liquid 70 is pushed out into the microchannel 21.

Also as shown in FIGS. 4 and 5, when the lid part 50 is capable of hermetically sealing the liquid reception part 40, the outer peripheral wall part 53 of the lid part 50 may be formed to have a protruding length smaller than the height of the outer surface 415 of the liquid storage part 41. In this configuration also, the recess part 54 formed between the outer peripheral wall part 53 and the protrusion part 52 can position the lid part 50 when the lid part 50 is attached to the liquid reception part 40, thus the recess part 54 serves as a guide to fit the protrusion part 52 in the liquid reception part 40, which improves workability.

Also as shown in FIGS. 4 and 5, the protrusion part 52 is not particularly required to have the tapered part 523 that swells gradually from the protruding end part toward the substantial center part thereof. With this configuration of the liquid introduction part 30, it is possible to form the inspection chip 1 having a simpler configuration while it is possible to rapidly introduce the liquid.

Also the knob part 57 provided on the lid part 50 may be formed on the end part of the outer peripheral wall part 53 as shown in FIG. 2 or on the side of the base part 51 as shown in FIG. 4, provided that it protrudes from the outer surface of the outer peripheral wall part 53.

### Embodiment 3

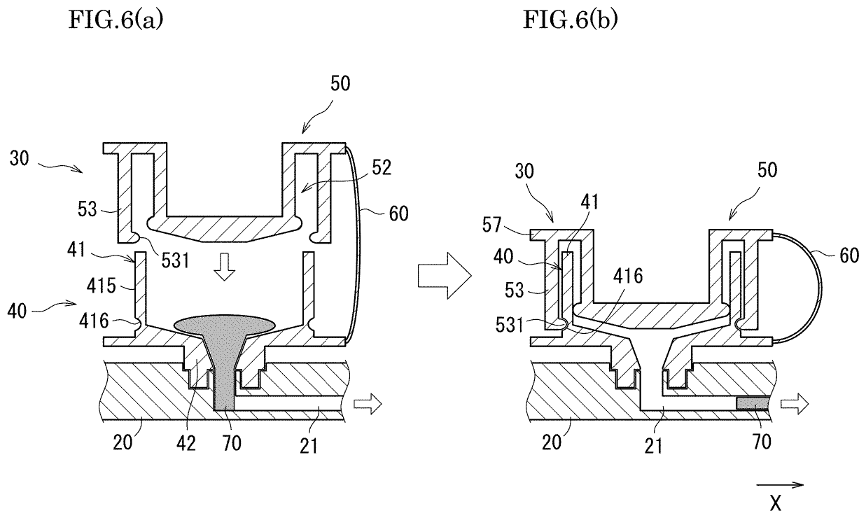

FIGS. 6(a) and 6(b) are cross-sectional views schematically illustrating the liquid introduction part 30 of the inspection chip 1 according to Embodiment 3.

In Embodiment 1, description was given on the liquid introduction part having the configuration in which the liquid storage part 41 protrudes from the body part 20. The liquid introduction part 30 of the inspection chip 1 may also have a configuration in which the liquid reception part 40 and the lid part 50 are engaged with each other.

For example, as shown in FIG. 6(a), the outer surface 415 of the liquid storage part 41 has a part to be locked (a locked part) 416 with which the lid part 50 is to be engaged. On the other hand, the lid part 50 has a locking part 531 to be engaged with the locked part 416 of the liquid storage part 41. In this case, the locked part 416 is a groove-like recess part formed in the lower part of the outer surface 415 of the liquid storage part 41. In contrast, the locking part 531 is formed as a convex part protruding in the direction of the protrusion part 52 from the end part of the outer peripheral wall part 53 of the lid part 50.

As shown in FIG. 6(b), when the liquid reception part 40 is sealed by the lid part 50, the locked part 416 of the liquid storage part 41 is engaged with the locking part 531 of the lid part 50, and accordingly, the lid part 50 is fixed to the liquid reception part 40. In this way, the lid part 50 is hardly detached, and the sealed state of the liquid reception part 40 is stably maintained. Also, at the time of sealing the liquid reception part 40 by the lid part 50, the lid part 50 can be pressed using, as a guide, engagement of the locking part 531 with the locked part 416. Thus, it is possible to reliably seal the liquid reception part 40.

Furthermore, as another configuration in which the liquid reception part and the lid part 50 are engaged with each other, the outer surface 415 of the liquid storage part 41 may have the locked part 416 as a convex part with which the locking part 531 of the lid part 50 is elastically engaged.

### Embodiment 4

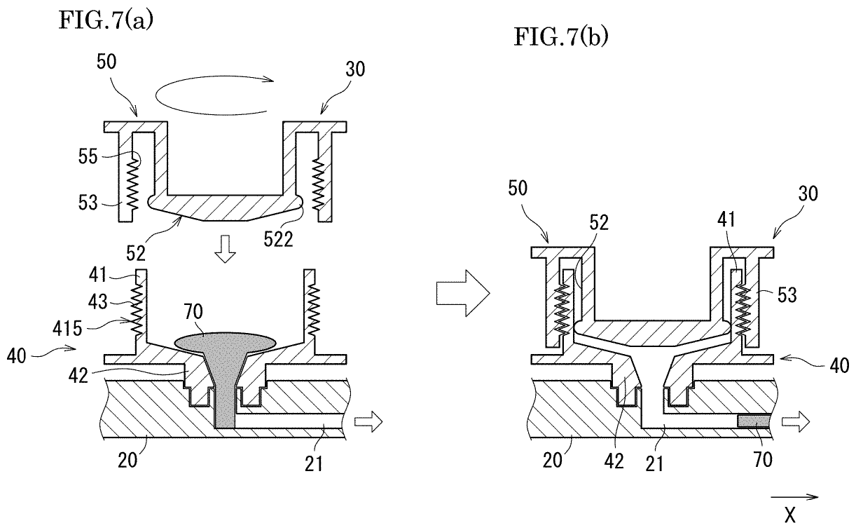

FIGS. 7(a) and 7(b) are cross-sectional views schematically illustrating the liquid introduction part 30 of the inspection chip 1 according to Embodiment 4.

In Embodiment 3, description was given on the configuration in which the liquid storage part 41 protrudes from the body part 20 and in which the liquid reception part 40 and the lid part 50 are engaged with each other so as to fix the lid part 50 to the liquid reception part 40. However, the configuration in which the lid part 50 is fixed to the liquid reception part 40 is not limited thereto. Both the lid part 50 and the liquid reception part 40 may have thread parts to be threadably engaged with each other.

For example, as shown in FIG. 7(a), the outer surface 415 of the cylindrical shaped liquid storage part 41 has an external thread 43 while the cylindrical shaped outer peripheral wall part 53 of the lid part 50 has, on the inner surface thereof, an internal thread 55 to be threadably engaged with the external thread 43 of the liquid storage part 41. In this case, the lid part 50 is rotated such that the internal thread 55 is screwed and threadably engaged with the external thread 43, and thus the liquid reception part 40 is sealed by the lid part 50.

As shown in FIG. 7(b), when the liquid reception part 40 is sealed by the lid part 50, the internal thread 55 of the outer peripheral wall part 53 is threadably engaged with the external thread 43 of the liquid storage part 41, and the lid part 50 is fixed to the liquid reception part 40. In this way, the lid part 50 is hardly detached, and the sealed state of the liquid reception part 40 is stably maintained. In this case where the thread structures are provided to make thread engagement, the liquid reception part 40 and the lid part 50 are each formed as a separate body, and no joining part 60 is needed between the liquid reception part 40 and the lid part 50. Alternatively, the liquid reception part 40 and the lid part 50 may be coupled by the joining part 60 having a loop such that the lid part 50 is rotatable.

### Embodiment 5

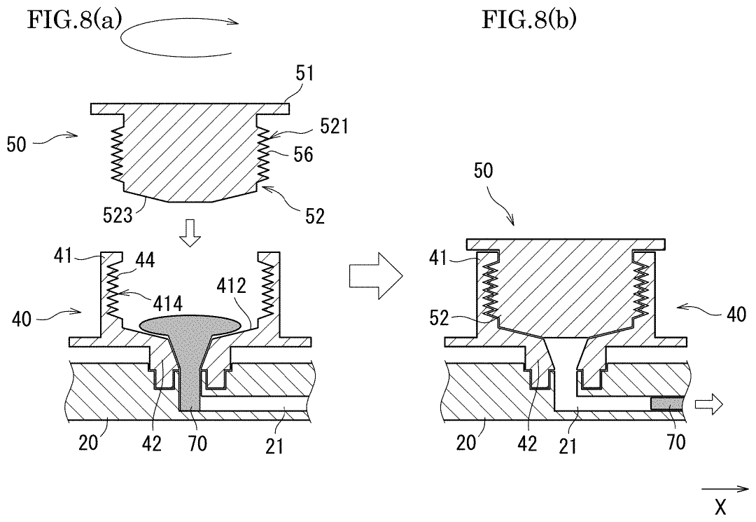

FIGS. 8(a) and 8(b) are cross-sectional views schematically illustrating the liquid introduction part 30 of the inspection chip 1 according to Embodiment 5.

In Embodiment 4, description was given on the configuration in which the external thread 43 is provided on the liquid reception part 40 while the internal thread 55 is provided on the lid part 50, as the configuration in which the lid part 50 is fixed to the liquid reception part 40. However, the inspection chip 1 of the present invention is not limited to the above configuration. An internal thread 44 may be provided on the liquid reception part 40 and an external thread 56 may be provided on the lid part 50 to the extent that they are formed as the thread structures to be threadably engaged with each other.

For example, as shown in FIG. 8(a), the inner surface 414 of the cylindrical shaped liquid storage part 41 may have the internal thread 44 while the outer surface 521 of the protrusion part 52 of the lid part 50 may have the external thread 56. In this case also, the lid part 50 is rotated such that the external thread 56 is screwed and threadably engaged with the internal thread 44, thus the liquid reception part 40 can be sealed by the lid part 50.

As shown in FIG. 8(b), when the liquid reception part 40 is sealed by the lid part 50, the external thread 56 of the protrusion part 52 is threadably engaged with the internal thread 44 of the liquid storage part 41, and the lid part 50 is fixed to the liquid reception part 40. In this way, the lid part 50 is hardly detached, and the sealed state of the liquid reception part 40 is stably maintained.

The lid part 50 may have the configuration including the outer peripheral wall part 53 similarly to the above Embodiments, or the configuration not including the outer peripheral wall part 53 as shown in FIG. 8. Also, when the lid part 50 is completely screwed, the tapered part 523 of the protrusion part 52 may reach the bottom part 412 of the liquid storage part 41.

### Embodiment 6

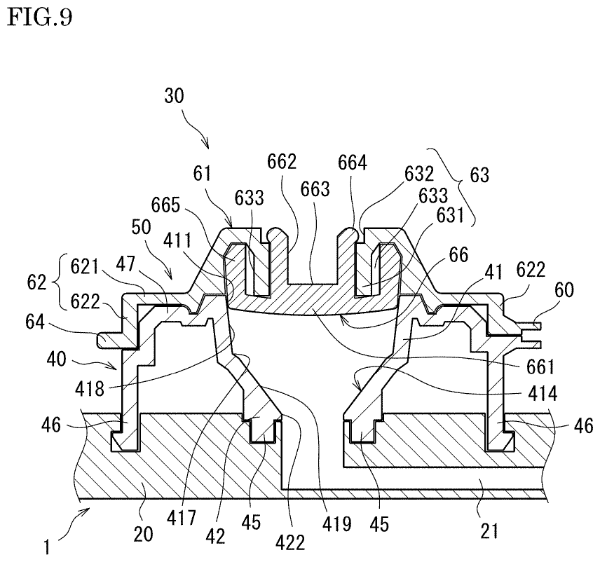

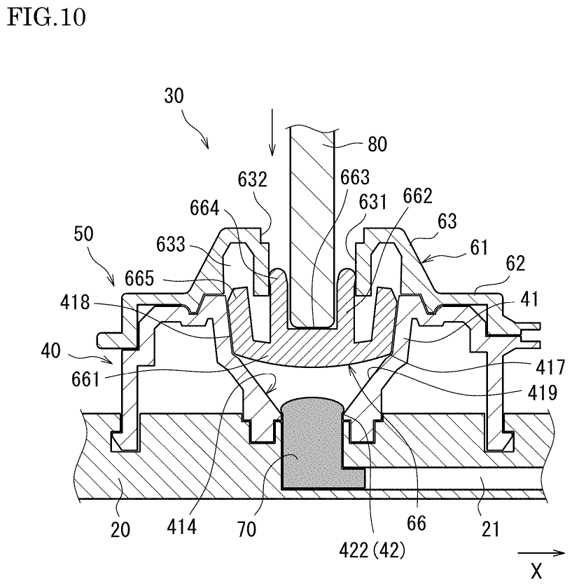

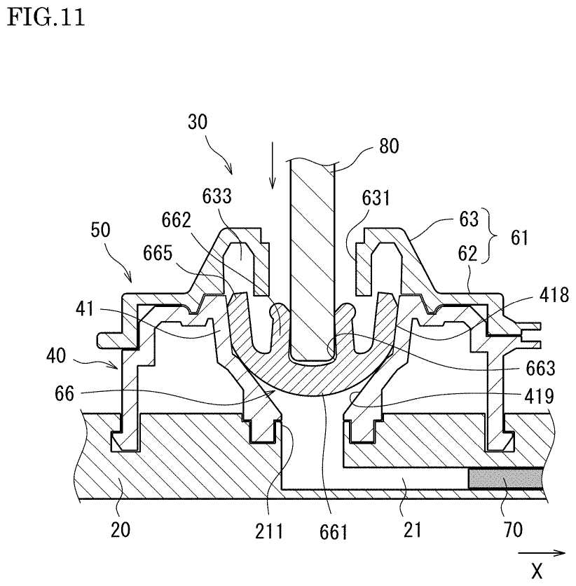

FIG. 9 is a cross-sectional view schematically illustrating the liquid introduction part 30 of the inspection chip 1 according to Embodiment 6. FIGS. 10 and 11 are cross-sectional views sequentially illustrating the state in which a protrusion part 66 provided on the lid part 50 is fitted in a liquid storage part 41. Each cross-section in these Figures illustrates the state in which the liquid reception part 40 is sealed by the lid part 50.

In the inspection chip 1 of the present invention, the lid part 50 of the liquid introduction part 30 is not limited to the configuration having, in an integral manner, the base part 51 and the protrusion part 52 that protrudes from one surface of the base part 51. The base part and the protrusion part may be provided each as a separate body.

That is, in the inspection chip 1 according to this Embodiment as exemplarily shown in FIG. 9, the lid part 50 to seal the liquid reception part 40 is provided with a lid body part 61 as the base part and the protrusion part 66, both are separated from each other. The protrusion part 66 is held by the lid body part 61.

The lid body part (base part) 61 includes: a cover part 62 that covers the upper part of the liquid reception part 40; and a holding part 63 that holds the protrusion part 66 provided as a separate body. The cover part 62 and the holding part 63 are integrally formed. The cover part 62 includes: a disc-shaped upper surface part 621 that covers the upper surface of the liquid reception part 40 so as to come into contact with the upper surface; and a rib part 622 that protrudes from the upper surface part 621 toward the liquid reception part 40 (i.e. downward in FIG. 9). A knob part 64 is protrudingly provided on the rib part 622 so as to extend outward.

The holding part 63 is disposed at a substantial center part of the lid body part 61 so as to expand upward from the upper surface part 621. The holding part 63 includes: a substantially cylindrical shaped inner wall part 631; a locking recess part 632 formed in an upper edge part of the inner wall part 631; and a fitting recess part 633 in which the protrusion part 66 is fitted. The inner wall part 631 is provided on the substantial center part of the lid body part 61. A through hole is formed inside the inner wall part 631 so as to penetrate inside and outside the lid body part 61. A protrusion part 66 is engaged with the locking recess part 632. The fitting recess part 633 is provided around the outer periphery of the inner wall part 631, and has a concave shape with the opening toward the liquid reception part 40 (i.e. downward in FIG. 9).

In the holding part 63, respective parts of the protrusion part 66 are disposed in the inside of the inner wall part 631 and in the fitting recess part 633, while a locking part 664 of the protrusion part 66 is engaged with the locking recess part 632. In this way, the protrusion part 66 is held by the holding part 63 of the lid body part 61.

The protrusion part 66 includes, in an integral manner: a body part 661; a cylindrical part 662 extending upward from the body part 661; and a fitting protrusion part 665 provided outside the cylindrical part 662. The body part 661 to cover the liquid reception part 40 is formed to have a size that can close the opening part 411 of the liquid storage part 41. The bottom surface of the body part 661 (i.e. the surface facing the liquid storage part 41) has a downward convex shape having a gentle curve.

The cylindrical part 662 of the protrusion part 66 is fitted in the inside of the inner wall part 631 of the holding part 63. The locking part 664 is formed on the end part of the cylindrical part 662 so as to extend outward. The locking part 664 is engaged with the locking recess part 632 of the holding part 63. The inside of the cylindrical part 662 is recessed toward the liquid storage part 41 and has a bottom part, which forms a pressing part 663. The fitting protrusion part 665 extends upward from the outer edge part of the body part 661 so as to be fitted in the fitting recess part 633. The protrusion part 66 is formed as a protrusion part so that the body part 661 is housed in the liquid storage part 41.

The lid body part 61 and the liquid reception part 40 are connected by the joining part 60 so as to be opened and closed. On the lid body part 61, a knob part 64 is protrudingly provided on the opposite side of the joining part 60. At the time of attaching the lid part 50 to the liquid reception part 40, an operator pinches the knob part 64 and covers the liquid reception part 40 with the cover part 62 so as to engage the respective components with each other.

On the other hand, in the liquid reception part 40, the liquid storage part 41 includes, in an integral manner: the connection part 42; a first fixed part 45; a second fixed part 46; and a contact part 47. The liquid reception part 40 is provided so as to protrude upward from the body part 20 of the inspection chip 1. As shown in FIG. 9, the first fixed part protruding downward from the connection part 42 and the second fixed part 46 provided outside the liquid storage part 41 are respectively engaged with recess parts formed in the upper surface of the body part 20. Thus, the liquid reception part 40 is fixed to the body part 20.

The contact part 47 of the liquid reception part 40 is a part to be covered with the upper surface part 621 of the cover part 62 of the lid body part 61. The contact part 47 has a concave/convex shape corresponding to the inner surface shape of the upper surface part 621, so that the contact part 47 and the upper surface part 621 are positioned to each other. The second fixed part 46 extends downward from the outer peripheral part of the contact part 47 to the body part 20. A projection may be formed at the lower end part of the second fixed part 46 so as to be engaged with the body part 20.

The liquid storage part 41 has the opening part 411 in the upper part thereof. The inner surface 414 has a tapered shape with a slope descending toward the connection part 42. On the periphery of the opening part 411, the contact part 47 is provided so as to extend outward. In the configuration exemplarily shown, the inner surface 414 of the liquid storage part 41 contains a first inclined part 418 on the upper side, and a second inclined part 419 on the lower side, with respect to a step part 417. The first inclined part 418 has a slope similar to the substantially cylindrical shape while the second inclined part 419 has a further gentle slope compared to the first inclined part 418 and thus has a funnel shape. The connection part 42 is provided in the lowermost part of the second inclined part 419 so as to connect the liquid storage part 41 and the microchannel 21. The connection part 42 has an opening 422 that is connected to the upstream end of the microchannel 21.

As described above, the liquid reception part 40 is protrudingly provided on the body part 20 with the liquid storage part 41 being the center part thereof. A hollow part is formed between the outer surface of the liquid storage part 41 and the second fixed part 46.

It is preferable that the liquid reception part 40 and the lid body part 61 are each integrally made of a thermoplastic material such as: polypropylene (PP) resin; polyethylene (PE) resin; polystyrene (PS) resin; or acrylonitrile butadiene styrene (ABS) resin. The liquid reception part 40 and the lid body part 61 may be made of the same resin material or respectively made of different resin materials.

In contrast to the above, it is preferable that the protrusion part 66 of the lid part 50 is made of an elastically deformable resin material such as polyolefin resin or elastomer. Examples of the resin materials suitable for forming the protrusion part 66 include: polypropylene (PP) resin; polyethylene (PE) resin; styrene-based elastomer; olefin based elastomer; polyester-based elastomer; and polyurethane-based elastomer.

Since the protrusion part 66 is provided as a separate body from the lid body part 61, the protrusion part 66 is movable to protrude from the lid body part 61, and furthermore is capable of being detached from the lid body part 61.

As shown in FIG. 9, the body part 661 of the protrusion part 66 is formed to have an outer diameter substantially corresponding to or slightly larger than the inner diameter of the opening part 411 of the liquid storage part 41. Also, the fitting protrusion part 665 of the protrusion part 66 is formed to have an outer diameter larger than the inner diameter of the opening part 411. The fitting protrusion part 665 is elastically deformed and bent with respect to the body part 661 so as to be fitted in the fitting recess part 633.

Unlike Embodiment 1 and the like as described above, in this Embodiment, the protrusion part 66 is held by the lid body part 61, and a part of the body part 661 is provided to protrude downward from the upper surface part 621 of the lid body part 61. In this state, the protrusion part 66 is movable downward, accordingly it can be fitted in the liquid storage part 41 through the opening part 411. Since the protrusion part 52 is elastic, it can be deformed when it is fitted in the liquid storage part 41. Thus, it is appressed to the inner surface 414 of the liquid storage part 41 so as to be hermetically fitted therein.

As shown in FIGS. 10 and 11, when the protrusion part 52 is housed in the liquid storage part 41, its general shape is deformed by coming into contact with the first inclined part 418 and the second inclined part 419 of the liquid storage part 41 so as to be appressed to the inner surface 414 of the liquid storage part 41. When the lid part 50 is attached to the liquid reception part 40 and the protrusion part 66 is housed in the liquid storage part 41, an airtight space is formed in the liquid storage part 41. As the protrusion part 66 further enters the liquid storage part 41, the airtight space becomes smaller. Thus, the liquid 70 can be pushed out into the microchannel 21. Note that it does not matter whether the protrusion part 66 comes into contact with the lowermost part of the liquid storage part 41 or not when the protrusion part 66 is completely housed in the liquid storage part 41.

In the liquid introduction method using the inspection chip 1 according to this Embodiment, the liquid 70 is injected into and stored in the liquid storage part 41 of the liquid reception part 40. Then, the lid part 50 is attached to the liquid reception part 40 by pinching and moving the knob part 64 of the lid part 50 (attaching step). As shown in FIG. 9, the lid part 50 is attached to the liquid reception part 40 by fitting the rib part 622 of the lid body part 61 in the top part of the second fixed part 46 of the liquid reception part 40 while covering the contact part 47 with the cover part 62. The protrusion part 66 is held by the holding part 63 of the lid body part 61, and the locking part 664 of the protrusion part 66 is engaged with the locking recess part 632 of the lid body part 61. The opening part 411 of the liquid storage part 41 is closed by the protrusion part 66.

Then, as shown in FIG. 10, a bar-like member 80 is inserted into the pressing part 663 of the protrusion part 66 so as to press the protrusion part 66 downward. Thus, the locking part 664 of the protrusion part 66 is disengaged from the locking recess part 632 of the lid body part 61 while the fitting protrusion part 665 is detached from the fitting recess part 633. The cylindrical part 662 slides on the inner surface of the inner wall part 631 of the lid body part 61 so as to move downward. The body part 661 enters the liquid storage part 41.

As the protrusion part 66 is detached from the lid body part 61 and enters the liquid storage part 41, the gas in the liquid storage part 41 is pressed downward. The fitting protrusion part 665 of the protrusion part 66 is deformed such that the outer surface thereof is appressed to the first inclined part 418 of the liquid storage part 41, and thus enters the liquid storage part 41. The liquid 70 in the liquid storage part 41 is pushed out into the microchannel 21 through the connection opening 422.

By continuously pressing the pressing part 663, the protrusion part 66 is further deformed and fitted in the liquid storage part 41, as shown in FIG. 11. For example, the body part 661 of the protrusion part 66 can also be deformed to be appressed to the second inclined part 419 of the liquid storage part 41. The liquid 70 introduced into the microchannel 21 is supplied, from the microchannel 21, to the microchannel 23 on the downstream side via the reaction part 25 (see FIG. 1).

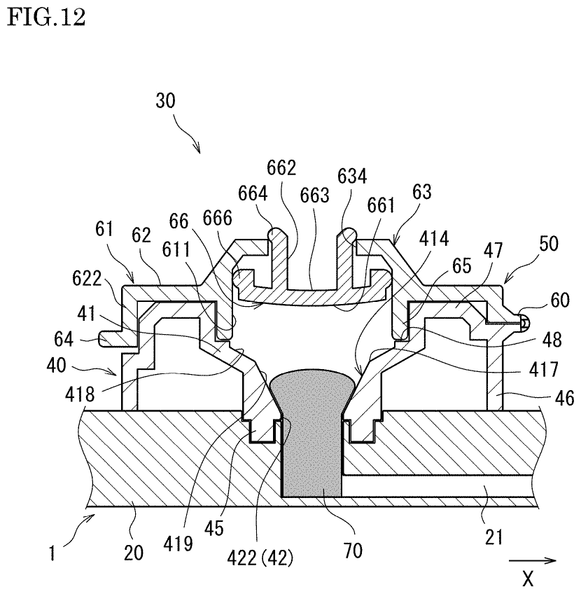

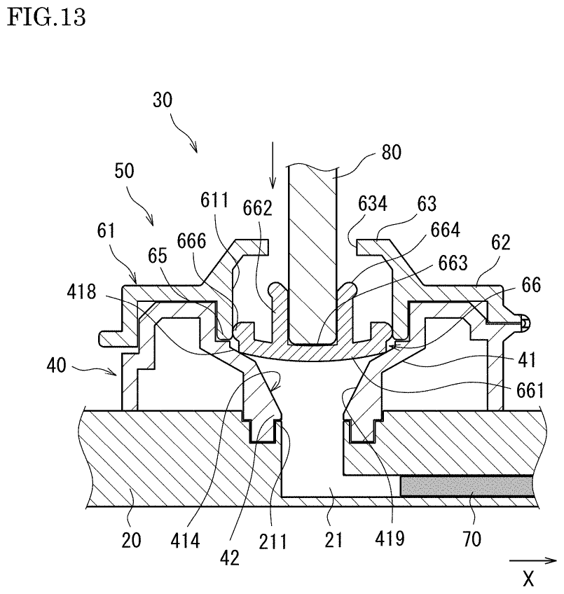

FIGS. 12 and 13 are cross-sectional views schematically illustrating another example of the liquid introduction part 30 of the inspection chip 1 according to Embodiment 6. FIG. 12 is a cross-sectional view of the liquid introduction part 30. FIG. 13 is a cross-sectional view illustrating a state in which the protrusion part 66 is fitted in the liquid storage part 41. In FIGS. 12 and 13, the same components as those in the example shown in FIG. 9 are indicated by the same reference numerals so as to omit the description thereof.

In the example shown in FIG. 12 also, the protrusion part 66 is provided as a separate body from the lid body part 61, and furthermore is capable of being detached from the lid body part 61. A through hole 634 is formed in the holding part 63 of the lid body part 61, into which the cylindrical part 662 of the protrusion part 66 is inserted. Also, the lid body part 61 is not provided with the inner wall part 631 shown in FIG. 9, which means that the lid body part 61 has a simpler configuration. In this case, the protrusion part 66 includes a sealing protrusion part 666 that is erected on the outer periphery of the body part 661. This sealing protruding part 666 is appressed to an inner surface 611 of the lid body part (base part) 61. The locking part 664 of the cylindrical part 662 is engaged with the upper edge part of the through hole 634 of the holding part 63. In this way, the protrusion part 66 is held by the lid body part 61.

Furthermore, the lid body part 61 includes a positioning part 65 that is fitted in the opening part 411 of the liquid storage part 41. As shown in FIG. 12, the positioning part 65 is protruded from the holding part 63 of the lid body part 61 toward the liquid reception part 40 (downward in FIG. 12) so as to be housed in the liquid storage part 41. When the lid part 50 is attached to the liquid reception part 40, an end part (lower end part) of the positioning part 65 goes into the liquid storage part 41 until it comes into contact with an engaging part 48 formed on the inner surface 414 as a step part and thus is stopped. As a result, the lid part 50 is appropriately positioned and attached to the liquid reception part 40.

Also, the inner surface 414 of the liquid storage part 41 includes the first inclined part 418, the step part 417 and the second inclined part 419, all of which are disposed under the positioning part 65. As shown in FIG. 12, the first inclined part 418 on the upper side may be formed to have a funnel shape whose slope is gentler than the slope of the second inclined part 419.

In the liquid introduction method in this case, the liquid 70 is injected into and stored in the liquid reception part 40. Then, the lid part 50 is attached to the liquid reception part 40 while the positioning part 65 is fitted in the liquid storage part 41. Successively, as shown in FIG. 13, the bar-like member 80 is inserted into the pressing part 663 of the protrusion part 66 so as to press the protrusion part 66 downward. Thus, the protrusion part 66 can be moved with the locking part 664 being detached from the through hole 634 of the lid body part 61. The sealing protrusion part 666 of the protrusion part 66 slides on the inner surface 611 of the lid body part 61 while being appressed to the inner surface 611. Thus, the protrusion part 66 enters the liquid storage part 41. The liquid 70 is pushed out into the microchannel 21. Since the protrusion part 66 is elastic, when it is further pressed from the state shown in FIG. 13, it can be deformed so that the body part 661 is appressed to the second inclined part 419 of the liquid storage part 41.

As described above, with the inspection chip 1 according to this Embodiment, it is also possible to easily introduce the liquid 70 into the microchannel 21 by attaching the lid part 50 to the liquid reception part and pressing the protrusion part 66. In this way, it is possible to rapidly feed the liquid 70 to the microchannels 21, 22 and 23, which improves rapidity of analysis of the liquid 70. The protrusion part 66 is not particularly limited to a separate body from the lid body part 61. For example, the protrusion part 66 and the lid body part 61 may be integrally formed via an elastic part or the like such that the protrusion part 61 is movable with respect to the lid part 61.

In the inspection chip 1 according to any of Embodiments 1 to 6, it is possible to seal the liquid reception part 40 by only a simple operation of attaching the lid part 50 to the liquid reception part 40, and at this time, the gas encapsulated in the liquid storage part 41 is pushed out by the protrusion part 52, which results in rapid introduction of the liquid 70 that is also pushed out from the liquid storage part 41 into the microchannel 21.

The present invention may be embodied in other forms without departing from the gist or essential characteristics thereof. The foregoing embodiments are therefore to be considered in all respects as illustrative and not limiting. The scope of the invention is indicated by the appended claims rather than by the foregoing description, and all modifications and changes that come within the meaning and range of equivalency of the claims are intended to be embraced therein. This application claims priority based on Japanese Patent Application No. 2020-107246. The entire contents thereof are hereby incorporated in this application by reference.

### DESCRIPTION OF REFERENCE NUMERALS

1 Inspection chip
20 Body part
21, 22, 23 Microchannel
211 Liquid inlet
24 Gas generation part
25 Reaction part
26 Analysis part
30 Liquid introduction part
40 Liquid reception part
41 Liquid storage part
411 Opening part
412 Bottom part
413 Connection opening
414 Inner surface
415 Outer surface
416 Locked part
418 First inclined part
419 Second inclined part
42 Connection part
421 Connection channel
422 Connection opening
43 External thread
44 Internal thread
50 Lid part
51 Base part
52 Protrusion part
521 Outer surface
522 Sealing protrusion part
523 Tapered part
53 Outer peripheral wall part
531 Locking part
54 Recess part
55 Internal thread
56 External thread
60 Joining part
61 Lid body part (base part)
62 Cover part
63 Holding part
65 Positioning part
66 Protrusion part
661 Body part
662 Cylindrical part
663 Pressing part
664 Locking part
665 Fitting protrusion part
666 Sealing protrusion part
70 Liquid

1. An inspection chip comprising: a body part including a microchannel; and a liquid introduction part introducing liquid into the microchannel, wherein
the liquid introduction part includes: a liquid reception part into which the liquid is injected; and a lid part capable of sealing the liquid reception part,
the liquid reception part includes: a liquid storage part having an opening part in an upper part thereof; and a connection part connecting the liquid storage part and the microchannel,
the lid part includes a protrusion part that protrudes so as to be fitted in the opening part and be housed in the liquid storage part when the liquid reception part is sealed, and furthermore the protrusion part hermetically enters the liquid storage part, and
the lid part is attached to the liquid reception part, and then the liquid in the liquid storage part is pushed out into the microchannel through the connection part.

2. The inspection chip according to claim 1, wherein
the liquid storage part has an inclined bottom part, and
the connection part connects a lowermost part of the bottom part and the microchannel.

3. The inspection chip according to claim 1, wherein
the protrusion part has a shape such that at least a part of the protrusion part comes into contact with an inner surface of the liquid storage part when the liquid reception part is sealed.

4. The inspection chip according to claim 1, wherein
the lid part includes: the protrusion part; and a base part holding the protrusion part, and
the protrusion part is movable with respect to the base part.

5. The inspection chip according to claim 4, wherein
the protrusion part is formed as a separate body from the base part, and is detachable from the base part.

6. The inspection chip according to claim 5, wherein
the protrusion part includes a locking part capable of being engaged with the base part.

7. The inspection chip according to claim 4, wherein
the protrusion part includes a pressing part that is a recess toward the liquid storage part.

8. The inspection chip according to claim 4, wherein
the base part includes a positioning part that protrudes so as to be fitted in the opening part and be housed in the liquid storage part.

9. The inspection chip according to claim 1, wherein
the protrusion part hermetically slides into the liquid storage part when the liquid reception part is sealed.

10. The inspection chip according to claim 1, wherein
the protrusion part includes a sealing protrusion part that protrudes outward from an outer surface of the protrusion part so as to be appressed to an inner surface of the liquid storage part.

11. The inspection chip according to claim 1, wherein
the protrusion part is elastically deformable.

12. The inspection chip according to claim 1, wherein
in the liquid introduction part, the liquid storage part is provided on the body part so as to protrude from the body part.

13. The inspection chip according to claim 12, wherein
an outer surface of the liquid storage part is provided with a part to be locked with which the lid part is engaged, and
the lid part is provided with a locking part that is engaged with the part to be locked.

14. The inspection chip according to claim 3, wherein
the liquid storage part and the lid part respectively have thread structures to be threadably engaged with each other, and
an external thread formed on either one of the liquid storage part and the lid part is threadably engaged with an internal thread formed on a remaining one of the liquid storage part and the lid part.

15. A liquid introduction method using an inspection chip including a liquid introduction part connected to a microchannel, the liquid introduction part including: a liquid reception part into which liquid is injected; and a lid part capable of sealing the liquid reception part, the lid part having a protrusion part protrudingly provided,
the liquid introduction method comprising the steps of:
injecting the liquid into the liquid reception part so that the liquid is stored; and
attaching the lid part to the liquid reception part, wherein
in the attaching step, the lid part seals the liquid reception part, then, as the protrusion part enters the liquid reception part, gas in the liquid reception part pushes out the liquid into the microchannel, and thus the liquid is introduced into the microchannel.

16. The liquid introduction method according to claim 15, wherein
the protrusion part is movable with respect to a base part of the lid part, and the protrusion part enters the liquid reception part by being pressed.
